(19) United States
(12) Patent Application Publication
(10) Pub. No.: US 2026/0236118 A1
(43) Pub. Date: Aug. 13, 2026

(54) INPUT SENSING PART, DISPLAY DEVICE INCLUDING INPUT SENSING PART, AND ELECTRONIC DEVICE INCLUDING DISPLAY DEVICE

(71) Applicant: Samsung Display Co., Ltd., Yongin-si (KR)

(72) Inventor: JUNGHA SON, Yongin-si (KR)

(21) Appl. No.: 19/328,700

(22) Filed: Sep. 15, 2025

(30) Foreign Application Priority Data
Feb. 7, 2025 (KR) 10-2025-0016125

(51) Int. Cl. G06F 3/041; G06F 3/044

(52) U.S. Cl. CPC G06F 3/0418; G06F 3/0446; G06F 3/0412; G06F 2203/04107; G06F 2203/04111; G06F 2203/04112

(57) ABSTRACT

An input sensing part includes: a sensing electrode; a dummy electrode adjacent to the sensing electrode; a sensing line adjacent to the dummy electrode, and extending to pass through the dummy electrode to be connected to the sensing electrode; and a shield electrode on the sensing line, and overlapping the sensing line in a plan view.

### CROSS-REFERENCE TO RELATED APPLICATIONS

The present application claims priority to and the benefit of Korean Patent Application No. 10-2025-0016125, filed on Feb. 7, 2025, in the Korean Intellectual Property Office, the entire disclosure of which is incorporated herein by reference.

### BACKGROUND

Aspects of some embodiments of the present disclosure described herein relate to an input sensing part, a display device including the input sensing part, and an electronic device including the display device.

Generally, electronic devices, which display images to users, such as smartphones, digital cameras, laptop computers, navigation systems, and smart televisions include a display device for displaying the images. The display device generates images and provides the users with the generated images through a display screen.

The display device includes a display panel generating images, and an input sensing part that is on a display panel to sense an external input. The input sensing part is on the display panel to sense a touch of the user as an external input. The input sensing part includes a plurality of sensing electrodes for sensing the external input, and sensing lines that are connected to the sensing electrodes.

A driving signal is applied to the sensing electrodes, and a change in the capacitance of the sensing electrodes is output as a sensing signal. The driving signal is applied to the sensing electrodes through sensing lines. When a driving signal having a specific frequency is applied to the sensing electrodes, electromagnetic waves according to the driving signal may be radiated as an unnecessary electromagnetic signal.

The electromagnetic signals may act as noise to other devices and may hinder the operations of other devices. This phenomenon may be defined as electromagnetic interferences (EMIs). Aspects of some embodiments may enable relatively reducing electromagnetic interferences.

The above information disclosed in this Background section is only for enhancement of understanding of the background and therefore the information discussed in this Background section does not necessarily constitute prior art.

### SUMMARY

Aspects of some embodiments of the present disclosure include an input sensing part that may prevent or reduce electromagnetic interferences, a display device including the input sensing part, and an electronic device including the display device.

According to some embodiments, an input sensing part includes a sensing electrode, a dummy electrode being adjacent to the sensing electrode, a sensing line being adjacent to the dummy electrode, and extending to pass through the dummy electrode to be connected to the sensing electrode, and a shield electrode on the sensing line, and overlapping the sensing line in a plan view.

According to some embodiments, a display device includes a display panel, and an input sensing part on the display panel, the input sensing part includes a sensing electrode, a dummy electrode being adjacent to the sensing electrode, a sensing line being adjacent to the dummy electrode, and extending to pass through the dummy electrode to be connected to the sensing electrode, a shield electrode on the sensing line and the dummy electrode, and overlapping the sensing line and the dummy electrode in the plan view, and a ground line under the dummy electrode, and electrically connected to the dummy electrode.

According to some embodiments, an electronic device includes a processor, and a display device that receives an image signal from the processor, and that provides a user with an image corresponding to the image signal, the display device includes a display panel, and an input sensing part on the display panel, and the input sensing part includes a sensing electrode, a dummy electrode being adjacent to the sensing electrode, a sensing line being adjacent to the dummy electrode, and extending to pass through the dummy electrode to be connected to the sensing electrode, and a shield electrode on the sensing line and the dummy electrode, and overlapping the sensing line and the dummy electrode in a plan view.

### BRIEF DESCRIPTION OF THE DRAWINGS

The above and other aspects and features of embodiments according to the present disclosure will become more apparent by describing in more detail aspects of some embodiments thereof with reference to the accompanying drawings.

FIG. 1 is a block diagram of an electronic device according to some embodiments of the present disclosure.

FIG. 2 illustrates schematic views of an electronic device according to some embodiments.

FIG. 3 is a perspective view of a display device according to some embodiments of the present disclosure.

FIG. 4 is a view illustrating a cross section of the display device illustrated in FIG. 3, by way of example.

FIG. 5 is a view illustrating a cross section of a display panel illustrated in FIG. 4, by way of example.

FIG. 6 is a view illustrating a cross section of a display panel according to some embodiments of the present disclosure.

FIG. 7 is a plan view of a display panel illustrated in FIG. 4.

FIG. 8 is a diagram illustrating a cross section of one pixel illustrated in FIG. 7.

FIG. 9 is a plan view of an input sensing part illustrated in FIG. 4.

FIG. 10 is a timing diagram of driving signals applied to sensing electrodes illustrated in FIG. 9.

FIG. 11 is a view illustrating an electromagnetic signal that may be generated according to the driving signals illustrated in FIG. 10.

FIG. 12 is an enlarged view of sensing electrodes, dummy electrodes, and sensing lines located in an h-th column illustrated in FIG. 9.

FIG. 13 is an enlarged view illustrating a detailed configuration of one sensing electrode, one dummy electrode, and one sensing line that are adjacent to each other in a first direction in FIG. 12.

FIG. 14 is a cross-sectional view taken along the line I-I′ illustrated in FIG. 13.

FIG. 15 is a cross-sectional view taken along the line II-II′ illustrated in FIG. 13.

FIG. 16 is a cross-sectional view taken along the line III-III′ illustrated in FIG. 13.

FIG. 17 is a cross-sectional view taken along the line IV-IV′ illustrated in FIG. 13.

FIG. 18 is a view illustrating a disposition position of a ground line according to some embodiments of the present disclosure.

FIGS. 19 to 23 are diagrams illustrating a configuration of shield electrodes according to some embodiments of the present disclosure.

### DETAILED DESCRIPTION

In the specification, the expression that a first component (or area, layer, part, portion, etc.) is “on”, “connected with”, or “coupled with” a second component means that the first component is directly on, connected with, or coupled with the second component or means that a third component is interposed therebetween.

The same reference numerals refer to the same components. Furthermore, in drawings, the thickness, ratio, and dimension of components are exaggerated for effectiveness of description of technical contents. The term “and/or” includes one or more combinations in each of which associated elements are defined.

Although the terms “first”, “second”, etc. may be used to describe various components, the components should not be construed as being limited by the terms. The terms are used only for the purpose of distinguishing one component, component, part, area, layer, or portion from another component, part, area, layer, or portion. For example, without departing from the scope of the present disclosure, a first component, a first part, a first area, a first layer, or a first portion may be referred to as a second component, a second part, a second area, a second layer, or a second portion, and similarly, a second component, a second part, a second area, a second layer, or a second portion may be referred to as a first component, a first part, a first area, a first layer, or a first portion. Singular forms include plural forms unless interpreted otherwise in context.

Also, the terms “under”, “below”, “on”, “above”, and the like are used to describe the correlation of components illustrated in drawings. The terms are relative concepts, and are described with respect to directions indicated in the drawings.

It will be understood that the terms “include”, “comprise”, “have”, and the like specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in the specification have the same meaning as commonly understood by one skilled in the art to which the present disclosure belongs. Furthermore, the terms, such as the terms defined in dictionaries, which are generally used, should be construed to coincide with the context meanings of the related technologies, and are not construed as ideal or excessively formal meanings unless explicitly defined in the present disclosure.

Hereinafter, aspects of some embodiments of the present disclosure will be described with reference to accompanying drawings.

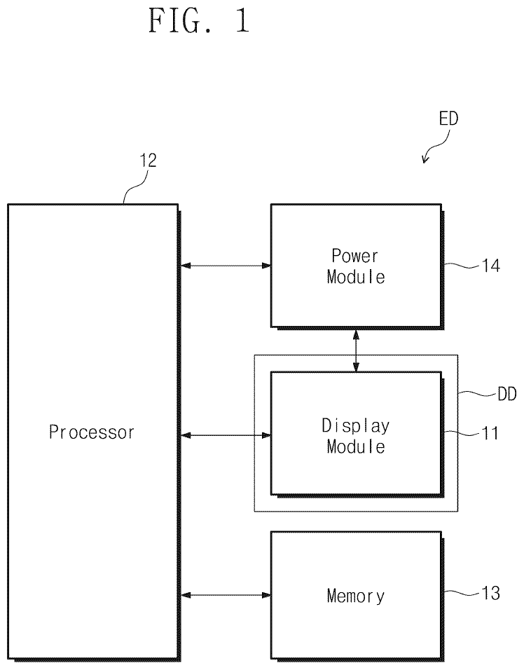

FIG. 1 is a block diagram of an electronic device according to some embodiments of the present disclosure.

Referring to FIG. 1, an electronic device ED according to some embodiments includes a display device DD that provides a user with an image, and may further include a module or device having other additional functions in addition to the display device DD. The electronic device ED according to some embodiments may include a display module 11, a processor 12, a memory 13, and a power module 14, and the display device DD may include a display module 11.

The processor 12 may include at least one of a central processing unit (CPU), an application processor (AP), a graphic processing unit (GPU), a communication processor (CP), an image signal processor (ISP), or a controller.

The processor 12 may process an image signal and provide it to the display device DD. The display device DD may receive an image signal from the processor 12 and provide an image corresponding to the image signal to a user.

The processor 12 may be electrically connected to a display module 11 of the display device DD through a flexible circuit board and a connector. The display module 11 may display an image based on data received from the processor 12.

According to some embodiments, the processor 12 may be divided into two or more parts from a functional or structural point of view to be provided. For example, the processor 12 may include a main processor in the form of a first driving chip including a central processing unit, and an auxiliary processor in the form of a second driving chip including a controller that receives an image signal from the main processor and processes the image signal to meet interface specifications of the display module 11.

Data information that are necessary for an operation of the processor 12 or the display module 11 may be stored in the memory 13. When the processor 12 executes an application stored in the memory 13, an image signal and/or an input control signal may be transmitted to the display module 11, and the display module 11 may process the provided image signal and output image information through a display screen.

The power module 14 may include a power supply module, such as a power adapter or a battery device, and a power conversion module that converts electric power supplied by the power supply module to generate electric power that is required for an operation of the electronic device ED.

At least one of the components of the electronic device ED described above may be included in the display device DD according to the above-described embodiments. Furthermore, some of the individual modules that are functionally included in one module may be included in the display device DD, and others may be provided separately from the display device DD. For example, the display device DD includes a display module 11, and the processor 12, the memory 13, and the power module 14 may be provided in the form of other devices in the electronic device ED rather than the display device DD.

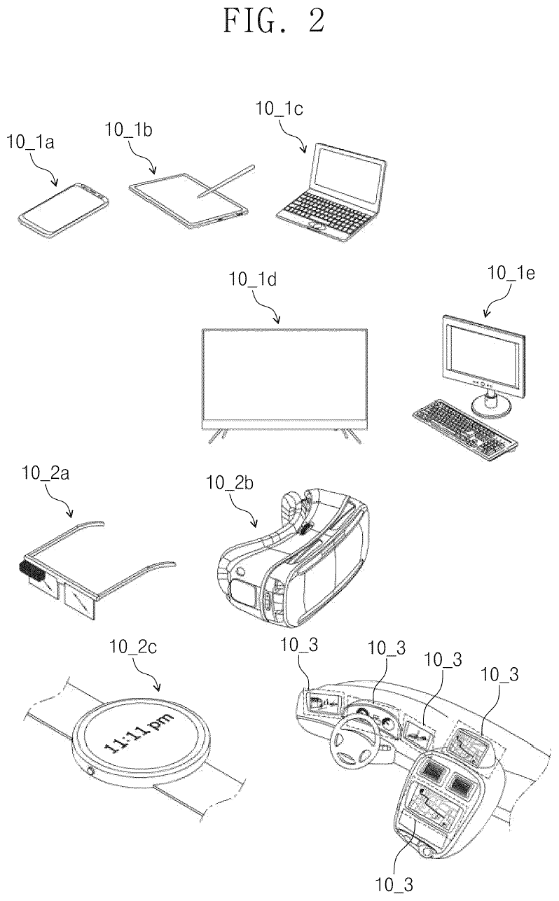

FIG. 2 illustrates schematic views of an electronic device according to some embodiments.

Referring to FIG. 2, the display device DD according to some embodiments of the present disclosure may be applied to various electronic devices. For example, various electronic devices, to which the display device DD according to some embodiments is applied, may include electronic devices for image display, such as a smartphone 10_1a, a tablet PC 10_1b, a laptop 10_1c, a TV 10_1d, or a desk monitor 10_1e.

Furthermore, various electronic devices, to which the display device DD according to some embodiments is applied, may include wearable electronic devices, such as smart glasses 10_2a, a head mounted display 10_2b, or a smart watch 10_2c. Furthermore, various electronic devices, to which the display device DD according to some embodiments is applied, may include electronic devices 10_3 for vehicles, such as an instrument panel for a vehicle, a center fascia, a center information display (CID) located on a dashboard, or a room mirror display.

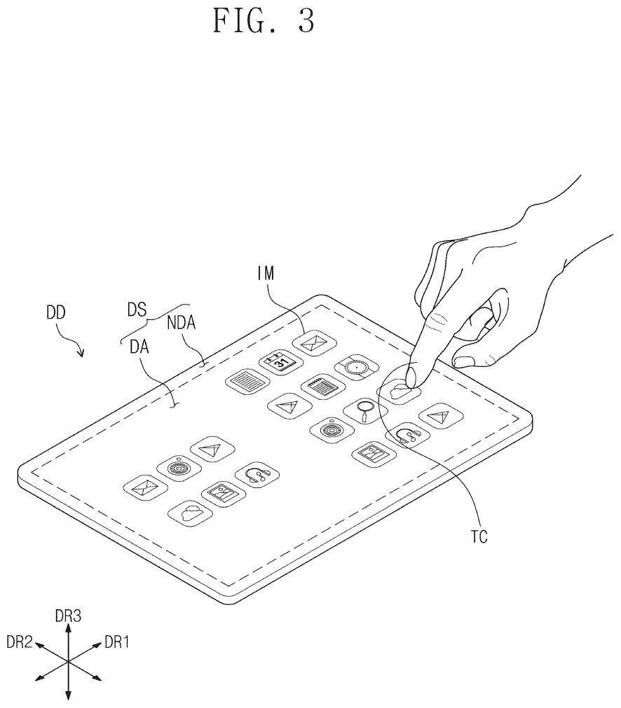

FIG. 3 is a perspective view of a display device according to some embodiments of the present disclosure.

Referring to FIG. 3, the display device DD according to some embodiments of the present disclosure may have long sides that extend in parallel in a first direction DR1 and short sides that extend in parallel in a second direction DR2 that crosses the first direction DR1. Corners of the display device DD, which connect the long sides and the short sides may have a curved shape. The corners of the display device DD having the curved shape may be defined as rounded corners. A shape of the display device DD may be defined as a round-cornered rectangular shape.

Hereinafter, a direction that is perpendicular to a plane defined by the first direction DR1 and the second direction DR2 is defined as a third direction DR3.

Moreover, in the specification, the meaning of “when viewed from above a plane” or “in a plan view” may be defined as “when viewed in the third direction DR3”.

A front surface of the display device DD may be defined as a display surface DS, and may have a plane defined by the first direction DR1 and the second direction DR2. Images IM generated by the display device DD may be provided to a user through the display surface DS.

The display surface DS may include a display area DA, and a non-display area NDA around (e.g., in a periphery or outside a footprint of) the display area DA. The display area DA may display images, and the non-display area NDA may not display images. The non-display area NDA may surround the display area DA, and may define a periphery of the display device DD, which is printed in a specific color.

The display device DD may sense inputs that are applied from the outside of the display device DD. For example, the display device DD may sense an input by a touch TC of the user.

According to some embodiments, the above-described electronic device ED may further include a camera and sensors that are located in the display device DD.

The sensors may be proximity light sensors, but the types of sensors are not limited thereto. The camera may photograph an external image.

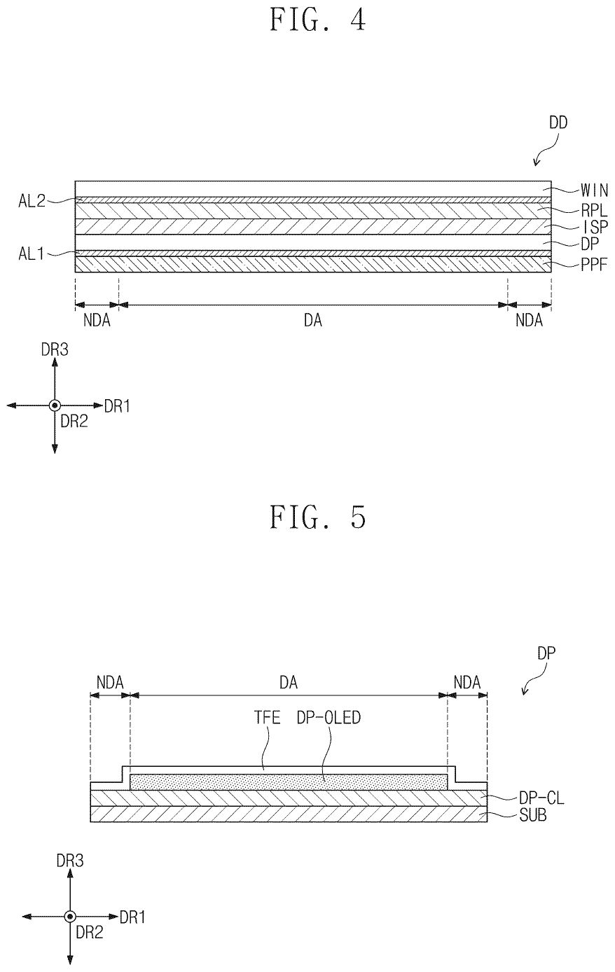

FIG. 4 is a view illustrating a cross section of the display device illustrated in FIG. 3, by way of example.

By way of example, FIG. 4 illustrates a cross section of the display device DD, when viewed in the second direction DR2.

Referring to FIG. 4, the display device DD may include a display panel DP, an input sensing part ISP, a reflection prevention layer RPL, a window WIN, a panel protection film PPF, and first and second adhesive layers AL1 and AL2. The above-described display module 11 may include the display panel DP, the input sensing part ISP, the reflection prevention layer RPL, and the panel protection film PPF illustrated in FIG. 3.

According to some embodiments of the present disclosure, the display panel DP may include a light emitting display panel. For example, the display panel DP may be an organic light emitting display panel or an inorganic light emitting display panel. An emission layer of the organic light emitting display panel may include an organic light emitting material. An emission layer of the inorganic light emitting display panel may include quantum dots and quantum rods. Hereinafter, it will be described that the display panel DP is an organic light emitting display panel.

The input sensing part ISP may be located on the display panel DP. The input sensing part ISP may include a plurality of sensing parts for sensing an external input in a capacitive manner. When the display device DD is manufactured, the input sensing part ISP may be directly manufactured on the display panel DP. However, embodiments according to the present disclosure are not limited thereto, and the input sensing part ISP may be manufactured as a separate panel from the display panel DP and be attached to the display panel DP by an adhesive layer.

The reflection prevention layer RPL may be located on the input sensing part ISP. When the display device DD is manufactured, the reflection prevention layer RPL may be directly manufactured on the input sensing part ISP. However, embodiments according to the present disclosure are not limited thereto, and the reflection prevention layer RPL may be manufactured as a separate panel, and may be attached to the input sensing part ISP by an adhesive layer.

The reflection prevention layer RPL may be defined as an external light reflection prevention film. The reflection prevention layer RPL may reduce a reflectance of external light that is input from a top surface of the display device DD toward the display panel DP. The external light may not be visually recognized by a user due to the reflection prevention layer RPL.

When external light directed toward the display panel DP is reflected from the display panel DP and is provided again to an external user, the user may visually recognize the external light, like a mirror. To prevent or reduce this phenomenon, the reflection prevention layer RPL may include a plurality of color filters for displaying the same colors as those of the pixels of the display panel DP.

The color filters may filter the external light to the same colors as those of the pixels. In this case, the external light may not be visually recognized by the user. However, the present disclosure is not limited thereto, and the reflection prevention layer RPL may include a phase retarder and/or a polarizer to reduce the reflectance of the external light.

The window WIN may be located on the reflection prevention layer RPL. The window WIN may protect the display panel DP, the input sensing part ISP, and the reflection prevention layer RPL from external scratches and impacts.

The panel protection film PPF may be located under the display panel DP. The panel protection film PPF may protect a lower side of the display panel DP. The panel protection film PPF may include a flexible plastic material such as Polyethyleneterephthalate (PET).

The first adhesive layer AL1 may be interposed between the display panel DP and the panel protection film PPF, and the display panel DP and the panel protection film PPF may be bonded to each other by the first adhesive layer AL1. The second adhesive layer AL2 may be interposed between the window WIN and the reflection prevention layer RPL, and the window WIN and the reflection prevention layer RPL may be bonded to each other by the second adhesive layer AL2.

FIG. 5 is a view illustrating a cross section of a display panel illustrated in FIG. 4, by way of example.

By way of example, FIG. 5 illustrates a cross section of the display panel DP, when viewed in the second direction DR2.

Referring to FIG. 5, the display panel DP may include a substrate SUB, a circuit element layer DP-CL that is located on the substrate SUB, a display element layer DP-OLED that is located on the circuit element layer DP-CL, and a thin film encapsulation layer TFE that is located on the display element layer DP-OLED.

The substrate SUB may include a display area DA, and a non-display area NDA around the display area DA. The substrate SUB may include glass or may include a flexible plastic material, such as or polyimide (PI). The display element layer DP-OLED may be located on the display area DA.

A plurality of pixels may be located on the circuit element layer DP-CL and the display element layer DP-OLED. Each of the pixels may include a transistor that is located on the circuit element layer DP-CL and a light emitting element that is located on the display element layer DP-OLED and is connected to the transistor.

A thin film encapsulation layer TFE may be located on the circuit element layer DP-CL to cover the display element layer DP-OLED. The thin film encapsulation layer TFE may protect pixels from moisture, oxygen, and foreign objects. The above-described input sensing part ISP may be directly located on the thin film encapsulation layer TFE.

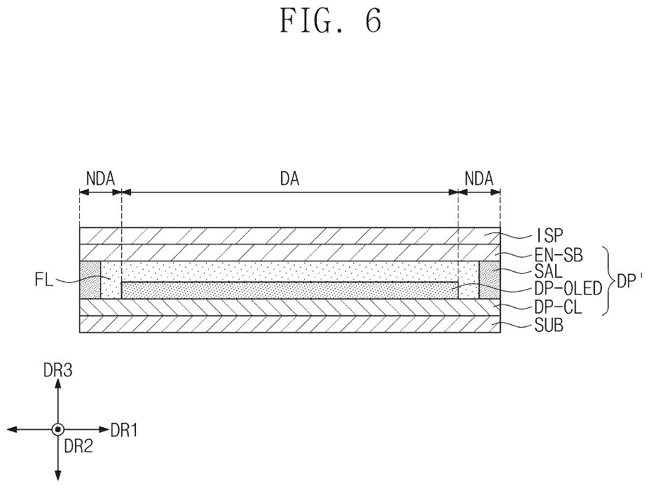

FIG. 6 is a view illustrating a cross section of a display panel according to some embodiments of the present disclosure.

By way of example, FIG. 6 illustrates a cross section of a display panel DP′ when viewed in the second direction DR2, and illustrates the input sensing part ISP together with the display panel DP'.

Referring to FIG. 6, the display panel DP′ may include a substrate SUB, a circuit element layer DP-CL, a display element layer DP-OLED, an encapsulation substrate EN-SB, a sealing layer SAL, and a filler FL. The circuit element layer DP-CL may be located on the substrate SUB, and the display element layer DP-OLED may be located on the circuit element layer DP-CL. The encapsulation substrate EN-SB may be located on the display element layer DP-OLED. The input sensing part ISP may be located directly on the encapsulation substrate EN-SB. The substrate SUB and the encapsulation substrate EN-SB may be of rigid type.

The sealing layer SAL may be interposed between the substrate SUB and the encapsulation substrate EN-SB. The sealing layer SAL may be located on the non-display area NDA. The sealing layer SAL may bond the substrate SUB and the encapsulation substrate EN-SB. The display element layer DP-OLED may be sealed between the substrate SUB and the encapsulation substrate EN-SB by the sealing layer SAL. The sealing layer SAL may include a photocurable material.

The filler FL may be located between the substrate SUB and the encapsulation substrate EN-SB. The filler FL may be located in a space sealed by the sealing layer SAL between the substrate SUB and the encapsulation substrate EN-SB. The filler FL may include a thermosetting material.

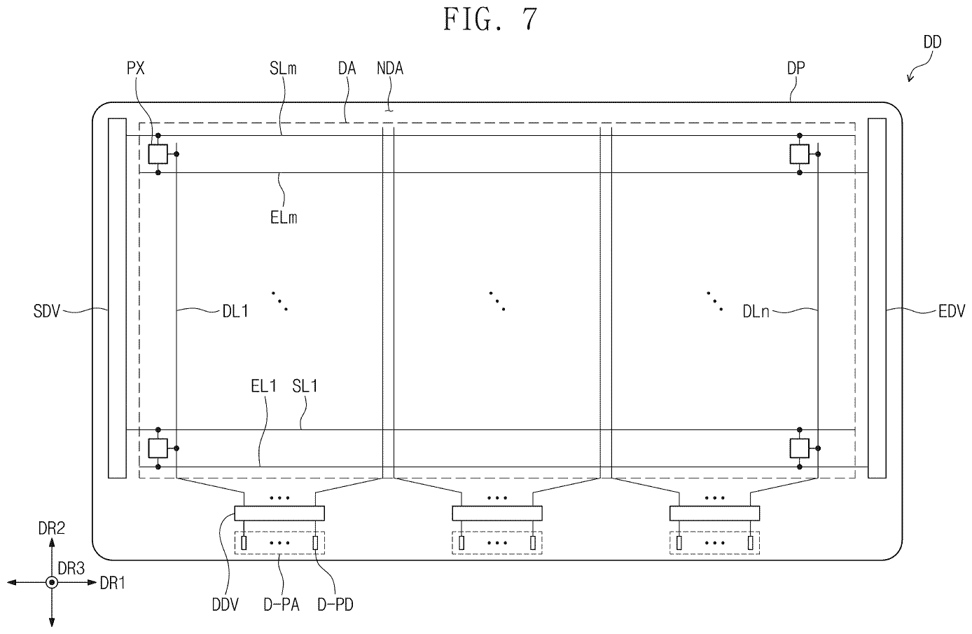

FIG. 7 is a plan view of a display panel illustrated in FIG. 4.

Referring to FIG. 7, the display device DD may include the display panel DP, a scan driver SDV, a plurality of data drivers DDV, an emission driver EDV, and a plurality of pads PD.

The display panel DP may have a rectangular shape having long sides that extend in the first direction DR1 and short sides that extend in the second direction DR2. However, embodiments according to the present disclosure are not limited thereto, and the display panel DP may have various shapes, such as a circle or a polygon.

The display panel DP may include a plurality of pixels PX, a plurality of scan lines SL1 to SLm, a plurality of data lines DL1 to DLn, and a plurality of emission lines EL1 to ELm. Each of “m” and “n” is a natural number. Areas of the display panel DP on a plane may include a display area DA, and a non-display area NDA that surrounds the display area DA.

The pixels PX may be located in the display area DA. The scan driver SDV and the emission driver EDV may be located in the non-display area NDA that is adjacent to opposite sides of the display panel DP, which are opposite to each other in the first direction DR1. The data drivers DDV may be located in a non-display area NDA that is adjacent to one of opposite sides of the display panel DP, which are opposite to each other in the second direction DR2. When viewed on a plane (or in a plan view), the data drivers DDV may be adjacent to a lower end of the display panel DP.

The scan lines SL1 to SLm may extend in the first direction DR1 to be connected to the pixels PX and the scan driver SDV. The data lines DL1 to DLn may extend in the second direction DR2 to be connected to the pixels PX and the data driver DDV. The emission lines EL1 to ELm may extend in the first direction DR1 to be connected to pixels PX and the emission driver EDV.

The data drivers DDV may be arranged in the first direction DR1. A specific number of data lines may be connected to each of the data drivers DDV. By way of example, three data drivers DDV are illustrated, but the number of the data drivers DDV is not limited thereto. For example, as the left and right areas of the display panel DP increase, the number of data drivers DDV may also increase.

The pads D-PD may be located in the non-display area NDA that is adjacent to a lower end of the display panel DP. The pads D-PD may be closer to a lower end of the display panel DP than to the data drivers DDV. The data drivers DDV may be connected to the pads D-PD. The data lines DL1 to DLn may be connected to the data drivers DDV, and the data drivers DDV may be connected to pads D-PD corresponding to the data lines DL1 to DLn.

A plurality of pad areas D-PA corresponding to the data drivers DDV, respectively, may be defined on the display panel DP. The pad areas D-PA may be closer to a lower end of the display panel DP than to the data drivers DDV. The pad areas D-PA may be arranged in the first direction DR1, and may be adjacent to the data drivers DDV in the second direction DR2, respectively. A specific number of pads D-PD may be located on each of the pad areas D-PA.

According to some embodiments, the display device DD may further include a timing controller for controlling operations of the scan driver SDV, the data drivers DDV, and the emission driver EDV. The timing controller may be connected to the pads D-PD through a printed circuit board. However, embodiments according to the present disclosure are not limited thereto, and the timing controller may be manufactured as an integrated IC with the data drivers DDV and be mounted on the display panel DP. Furthermore, the timing controller and the data drivers DDV may be manufactured as an integrated IC and be connected to the display panel DP through a flexible circuit board.

The scan driver SDV may generate a plurality of scan signals, and the scan signals may be applied to the pixels PX through the scan lines SL1 to SLm. The data driver DDV may generate a plurality of data voltages, and the data voltages may be applied to the pixels PX through the data lines DL1 to DLn. The emission driver EDV may generate a plurality of emission signals, and the emission signals may be applied to the pixels PX through the emission lines EL1 to ELm.

The pixels PX may receive the data voltages in response to the scan signals. The pixels PX may display an image by emitting light of a luminance corresponding to the data voltages in response to the emission signals.

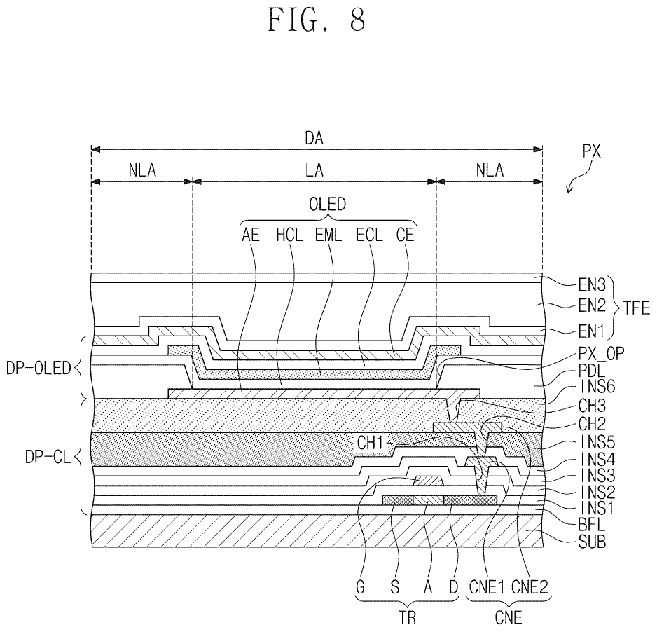

FIG. 8 is a diagram illustrating a cross section of one pixel illustrated in FIG. 7.

Referring to FIG. 8, a pixel PX may include a transistor TR and a light emitting element OLED. The light emitting element OLED may include a first electrode AE (or an anode), a second electrode CE (or a cathode), a hole control layer HCL, an electron control layer ECL, and an emission layer EML.

The transistor TR and the light emitting element OLED may be located on the substrate SUB. Although one transistor TR is illustrated by way of example, substantially, the pixel PX may include a plurality of transistors and at least one capacitor for driving the light emitting element OLED.

The display area DA may include an emission area LA corresponding to each of the pixels PX and a non-emission area NLA around the emission area LA. The light emitting element OLED may be located in the emission area LA.

A buffer layer BFL may be located on the substrate SUB, and the buffer layer BFL may be an inorganic layer. A semiconductor pattern may be located on the buffer layer BFL. The semiconductor pattern may include polysilicon, amorphous silicon, or metal oxide.

The semiconductor pattern may be doped with an N-type dopant or a P-type dopant. The semiconductor pattern may include a highly-doped area and a lightly-doped area. A conductivity of the highly-doped area may be greater than that of the lightly-doped area, and substantially, may serve as a source electrode and a drain electrode of the transistor TR. The lightly-doped area may substantially correspond to an active (or a channel) of the transistor.

A source “S”, an active “A”, and a drain “D” of the transistor TR may be formed from the semiconductor pattern. A first insulating layer INS1 may be located on the semiconductor pattern. A gate “G” of the transistor TR may be located on the first insulating layer INS1. A second insulating layer INS2 may be located on the gate “G”. A third insulating layer INS3 may be located on the second insulating layer INS2.

To connect the transistor TR and the light emitting element OLED, a connection electrode CNE may include a first connection electrode CNE1 and a second connection electrode CNE2. The first connection electrode CNE1 may be located on the third insulating layer INS3, and may be connected to the drain “D” through a first contact hole CH1 that is defined in the first to third insulating layers INS1 to INS3.

The fourth insulating layer INS4 may be located on the first connection electrode CNE1. The fifth insulating layer INS5 may be located on the fourth insulating layer INS4. The second connection electrode CNE2 may be located on the fifth insulating layer INS5. The second connection electrode CNE2 may be connected to the first connection electrode CNE1 through a second contact hole CH2 that is defined in the fourth and fifth insulating layers INS4 and INS5.

The second connection electrode CNE2 may be located on the sixth insulating layer INS6. Layers from the buffer layer BFL to the sixth insulating layer INS6 may be defined as a circuit element layer DP-CL. The first to sixth insulating layers INS1 to INS6 may be inorganic layers or organic layers.

The first electrode AE may be located on the sixth insulating layer INS6. The first electrode AE may be connected to the second connection electrode CNE2 through a third contact hole CH3 that is defined in the sixth insulating layer INS6. A pixel definition film PDL, in which an opening PX_OP for exposing a specific portion of the first electrode AE is defined, may be located on the first electrode AE and the sixth insulating layer INS6.

The hole control layer HCL may be located on the first electrode AE and the pixel definition film PDL. The hole control layer HCL may include a hole transport layer and a hole injection layer.

The emission layer EML may be located on the hole control layer HCL. The emission layer EML may be located in an area corresponding to the opening PX_OP. The emission layer EML may include an organic material and/or an inorganic material. The emission layer EML may generate one of red light, green light, and blue light.

The electron control layer ECL may be located on the emission layer EML and the hole control layer HCL. The electron control layer ECL may include an electron transport layer and an electron injection layer. The hole control layer HCL and the electron control layer ECL may be located in common in an emission area LA and a non-emission area NLA.

The second electrode CE may be located on the electron control layer ECL. The second electrode CE may be arranged in the pixels PX in common. The layer, in which the light emitting element OLED is located, may be defined as a display element layer DP-OLED.

The thin film encapsulation layer TFE may be located on the second electrode CE to cover the pixel PX. The thin film encapsulation layer TFE may include a first encapsulation layer EN1 that is located on the second electrode CE, a second encapsulation layer EN2 that is located on the first encapsulation layer EN1, and a third encapsulation layer EN3 that is located on the second encapsulation layer EN2.

The first and third encapsulation layers EN1 and EN3 may include an inorganic insulating layer, and may protect the pixel PX from moisture/oxygen. The second encapsulation layer EN2 may include an organic insulating layer, and may protect the pixel PX from foreign substances, such as dust particles.

A first voltage may be applied to the first electrode AE, and a second voltage having a lower level than that of the first voltage may be applied to the second electrode CE. Excitons may be formed by coupling holes and electrons that are injected into the emission layer EML, and as the excitons transit to a ground state, the light emitting element OLED may emit light.

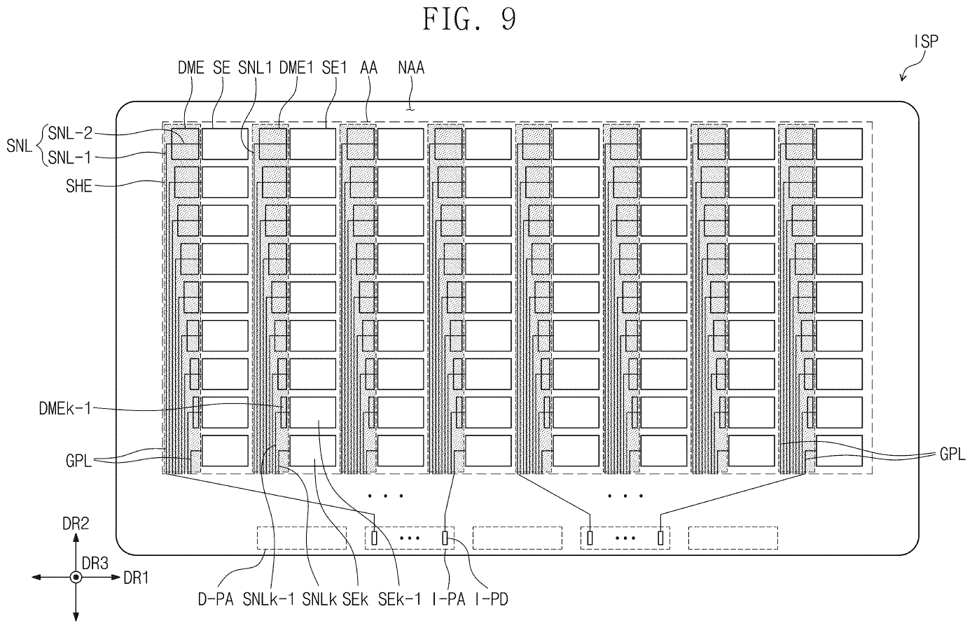

FIG. 9 is a plan view of an input sensing part illustrated in FIG. 4.

By way of example, in FIG. 9, the pad areas D-PA described above are illustrated together with the input sensing part ISP. In FIG. 9, the pad areas D-PA are illustrated by dotted lines.

Referring to FIG. 9, the input sensing part ISP may include a plurality of sensing electrodes SE, a plurality of dummy electrodes DME, a plurality of sensing lines SNL, a plurality of shield electrodes SHE, and a plurality of pads I-PD. By way of example, in FIG. 9, the shield electrodes SHE are illustrated in gray, and the peripheries of the shield electrodes SHE is illustrated in dotted lines.

A planar area of the input sensing part ISP may include an active area AA and a non-active area NAA that surrounds the active area AA. The active area AA may overlap the display area DA and the non-active area NAA may overlap the non-display area NDA.

The sensing electrodes SE may be located in the active area AA. The sensing electrodes SE may be arranged in the first direction DR1 and the second direction DR2. By way of example, the sensing electrodes SE may have a rectangular shape, but the shape of the sensing electrodes SE is not limited thereto. When viewed on a plane (or in a plan view), the sensing electrodes SE may have the same shape and the same extent.

The dummy electrodes DME may be located in the active area AA. The dummy electrodes DME may be arranged in the first direction DR1 and the second direction DR2. The dummy electrodes DME may be adjacent to the sensing electrodes SE in the first direction DR1. By way of example, the dummy electrodes DME may have a rectangular shape, but the shape of the dummy electrodes DME is not limited thereto.

Hereinafter, the column corresponds to the second direction DR2. The sensing electrodes SE and the dummy electrodes DME may be arranged in a plurality of columns.

Widths of the dummy electrodes DME arranged in an h-th column in the first direction DR1 may gradually decrease as they go downward. “h” is a natural number.

The dummy electrodes DME arranged in the h-th column may be adjacent to the sensing electrodes SE arranged in the h-th column in the first direction DR1. When the number of the sensing electrodes SE arranged in the h-th column is “k”, the number of the dummy electrodes DME arranged in the h-th column may be k-1. “k” may be a natural number of 2 or more.

When the order is sequentially set from the uppermost side in the h-th column, the first to (k-1)-th dummy electrodes DME1 to DMEk-1 may be adjacent to the first to (k-1)-th sensing electrodes SE1 to SEk-1 in the first direction DR1, respectively. The first to (k-1)-th dummy electrodes DME1 to DMEk-1 may be adjacent to ones (e.g., the left sides in FIG. 9) of opposite sides of the first to (k-1)-th sensing electrodes SE1 to SEk-1, which are opposite to each other in the first direction DR1. A dummy electrode DME may not be located on one side of the k-th sensing electrode SEk.

The sensing electrodes SE may have unique coordinate information. For example, the sensing electrodes SE may be arranged in a matrix form, and may have coordinate information according to an arrangement form of the matrix. However, the arrangement form of the sensing electrodes SE is not limited thereto, and they may be variously arranged.

The sensing lines SNL may be located in the active area AA to be adjacent to the dummy electrodes DME. The sensing lines SNL may pass through the dummy electrodes DME to be connected to the sensing electrodes SE. The sensing lines SNL may extend to the non-active area NAA.

Openings, through which the sensing lines SNL pass, are defined in the dummy electrodes DME, and the configuration of the openings will be illustrated in FIG. 13. The sensing lines SNL may be connected to ones of opposite sides (e.g., left sides in FIG. 9) of the sensing electrodes SE, which are opposite to each other in the first direction DR1.

The sensing lines SNL may be grouped into a plurality of line groups GPL.

Each of the line groups GPL may include “k” sensing lines SNL. The line groups GPL may be arranged in the first direction DR1. The sensing lines SNL of each of the line groups GPL may be located adjacent to each other.

The sensing lines SNL of the h-th line group GPL may be connected to sides (e.g., left sides in FIG. 9) of the sensing electrodes SE arranged in the h-th column, respectively. The sensing lines SNL may extend in the second direction DR2 and the first direction DR1 to be connected to the sensing electrodes SE.

Each of the sensing lines SNL may include a first sub-sensing line SNL-1 that extends in the second direction DR2 and a second sub-sensing line SNL-2 that extends in the first direction DR1. The second sub-sensing line SNL-2 may be bent from the first sub-sensing line SNL-1 to extend in the first direction DR1.

In the h-th line group GPL, the first to (k-1)-th dummy electrodes DME1 to DMEk-1 may be located between the first sub-sensing lines SNL-1 of the first to (k-1)-th sensing lines SNL1 to SNLk-1 and the first to (k-1)-th sensing electrodes SE1 to SEk-1. In the h-th line group GPL, the dummy electrode DME may not be located between the k-th sensing line SNLk and the k-th sensing electrode SEk.

In the h-th line group GPL, the first to (k-1)-th sensing lines SNL1 to SNLk-1 may pass through the first to (k-1)-th dummy electrodes DME1 to DMEk-1 to be connected to the first to (k-1)-th sensing electrodes SE1 to SEk-1, respectively. For example, the second sub-sensing lines SNL-2 of the first to (k-1)-th sensing lines SNL1 to SNLk-1 may extend to pass through the first to (k-1)-th dummy electrodes DME1 to DMEk-1 to be connected to the first to (k-1)-th sensing electrodes SE1 to SEk-1, respectively. The k-th sensing line SNLk may be connected to the k-th sensing electrode SEk.

The sensing lines SNL may extend to the non-active area NAA that is adjacent to a lower end of the input sensing part ISP. The pads I-PD may be located in the non-active area NAA that is adjacent to a lower end of the input sensing part ISP. The sensing lines SNL may be connected to the pads I-PD, respectively.

A plurality of pad areas I-PA may be defined in the input sensing part ISP. A specific number of pads I-PD may be located on each of the pad areas I-PA. The pad areas I-PA may be arranged in the first direction DR1. The pad areas I-PA of the input sensing part ISP may be located between the pad areas D-PA of the display panel DP in the first direction DR1. Accordingly, when viewed on a plane (or in a plan view), the pad areas I-PA may not overlap the pad areas D-PA.

The shield electrodes SHE may extend in the second direction DR2, and may be arranged in the first direction DR1. The shield electrodes SHE may be located on the sensing lines SNL and the dummy electrodes DME. A stack structure of the shield electrodes SHE, the sensing lines SNL, and the dummy electrodes DME will be described in more detail below.

When viewed on a plane (or in a plan view), the shield electrodes SHE may overlap the sensing lines SNL and the dummy electrodes DME. For example, the h-th shield electrode SHE may overlap the sensing lines SNL of the h-th line group GPL and the dummy electrodes DME arranged in the h-th column.

According to some embodiments, an input sensing controller that controls an operation of the input sensing part ISP may be connected to the pads I-PD through a printed circuit board.

The input sensing part ISP according to some embodiments of the present disclosure may be driven in a self-sensing mode to acquire coordinate information in a self-cap method. For example, the input sensing controller may apply a driving signal to the sensing electrodes SE through the pads I-PD and the sensing lines SNL, and may receive sensing signals from the sensing electrodes SE.

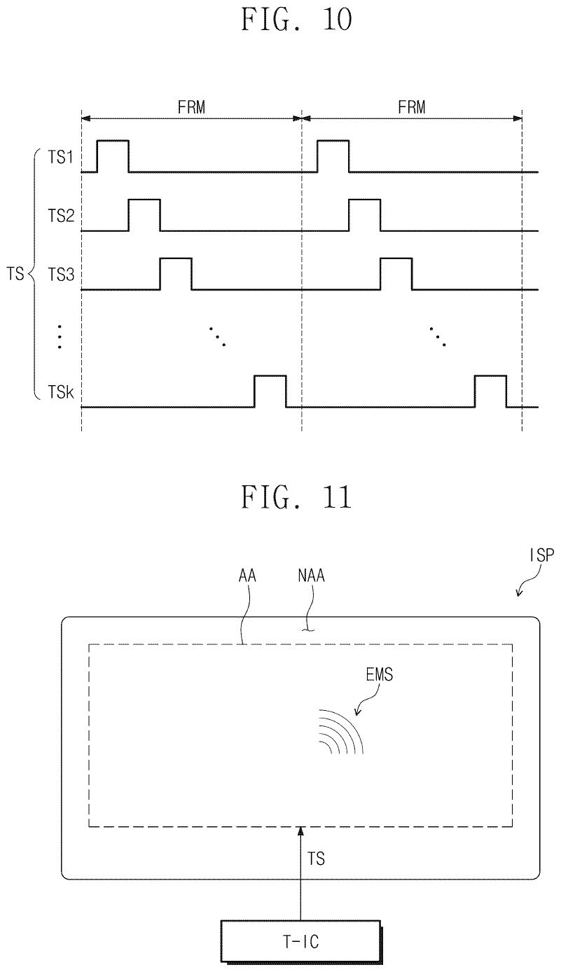

FIG. 10 is a timing diagram of driving signals applied to sensing electrodes illustrated in FIG. 9. FIG. 11 is a view illustrating an electromagnetic signal that may be generated according to the driving signals illustrated in FIG. 10.

Referring to FIGS. 9, 10, and 11, an input sensing controller T-IC may generate driving signals TS. The driving signals TS may be applied to the sensing electrodes SE for each frame FRM. The driving signals TS may include first to k-th driving signals TS1 to TSk. The first to k-th driving signals TS1 to TSk may be applied to the first to k-th sensing lines SNL1 to SNLk of each of the line groups GPL, respectively.

An electromagnetic signal EMS may be generated in the input sensing part ISP by a driving signal TS having a specific frequency. The electromagnetic signal EMS may be radiated to the outside. That is, electromagnetic waves according to the driving signals may be radiated as unnecessary electromagnetic signals. The electromagnetic signals may act as noise to other external devices, and may hinder the operations of other devices according to electromagnetic interferences (EMIs).

According to some embodiments of the present disclosure, the shield electrodes SHE may be located on the sensing lines SNL, to which the driving signals TS are applied, and the shield electrodes SHE may shield electromagnetic signals that may be radiated to the outside. Accordingly, electromagnetic interferences with the external devices may be prevented or reduced.

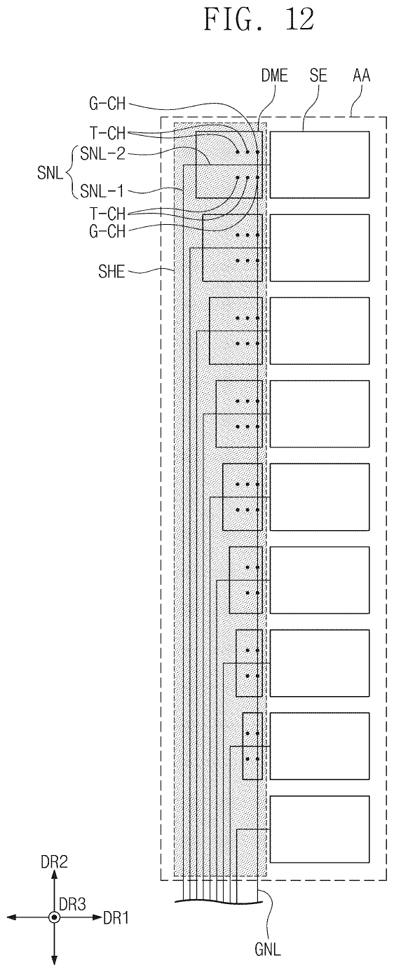

FIG. 12 is an enlarged view of sensing electrodes, dummy electrodes, and sensing lines located in an h-th column illustrated in FIG. 9.

Referring to FIG. 12, the display device DD may further include a ground line GNL. The ground line GNL may extend in the second direction DR2. The ground line GNL may overlap the dummy electrodes DME. Substantially, a plurality of ground lines GNL may be provided, and the plurality of ground lines GNL may overlap the dummy electrodes DME arranged in a plurality of columns illustrated in FIG. 9.

The ground line GNL may be connected to the dummy electrodes DME through contact holes G-CH. A cross-sectional configuration of the contact holes G-CH will be illustrated in FIG. 15. The ground line GNL may receive a ground voltage.

The shield electrode SHE may be connected to the dummy electrodes DME through contact holes T-CH. A cross-sectional configuration of the contact holes T-CH will be illustrated in FIG. 15.

FIG. 13 is an enlarged view illustrating a detailed configuration of one sensing electrode, one dummy electrode, and one sensing line that are adjacent to each other in a first direction in FIG. 12.

Referring to FIG. 13, the sensing electrode SE, the dummy electrode DME, and the sensing line SNL may have a mesh shape. Each of the sensing electrode SE, the dummy electrode DME, and the sensing line SNL may include a plurality of first branch parts BP1 that extend in a first diagonal direction DDR1 and a plurality of second branch parts BP2 that extend in a second diagonal direction DDR2.

The first diagonal direction DDR1 may be defined as a direction that crosses the first and second directions DR1 and DR2 on a plane defined by the first and second directions DR1 and DR2. The second diagonal direction DDR2 may be defined as a direction that crosses the first diagonal direction DDR1 on a plane defined by the first and second directions DR1 and DR2. By way of example, the first direction DR1 and the second direction DR2 may perpendicularly cross each other, and the first diagonal direction DDR1 and the second diagonal direction DDR2 may perpendicularly cross each other.

In each of the sensing electrode SE, the dummy electrode DME, and the sensing line SNL, the first branch parts BP1 and the second branch parts BP2 may cross each other and may be integrally formed with each other. Rhombus-shaped touch openings TOP may be defined by the first branch parts BP1 and the second branch parts BP2.

Emission areas LA may be located in the touch openings TOP. By way of example, five emission areas LA located in five touch openings TOP are illustrated in any number, but the emission areas LA may be located in all the touch openings TOP.

Each of the emission areas LA may be an emission area LA illustrated in FIG. 8. That is, the light emitting elements OLED located in the emission areas LA may be located in the touch openings TOP. By way of example, emission areas LA are arranged to correspond to touch openings TOP in one-to-one correspondence, but embodiments of the present disclosure are not limited thereto. For example, a plurality of emission areas LA may be located in one touch opening TOP.

The first and second branch parts BP1 and BP2 may be located in the non-emission area NLA without overlapping the emission areas LA. That is, the sensing electrode SE, the dummy electrode DME, and the sensing line SNL may be located in the non-emission area NLA without overlapping the emission areas LA. Because the sensing electrode SE, the dummy electrode DME, and the sensing line SNL are located in the non-emission area NLA, light generated in the emission areas LA may be normally emitted without being influenced by the sensing electrode SE, the dummy electrode DME, and the sensing line SNL.

The shield electrode SHE illustrated in gray may be provided in the form of a whole electrode. For example, the shield electrode SHE may be formed in the form of a whole plate (or a flat plate) without an opening (e.g., a touch opening TOP). The shield electrode SHE provided in the form of a whole electrode may overlap the sensing line SNL and the dummy electrode DME having a mesh shape when viewed on a plane (or in a plan view) to cover the sensing line SNL and the dummy electrode DME.

The first sub-sensing line SNL-1 may have a mesh shape and extend in the second direction DR2. The second sub-sensing line SNL-2 may have a mesh shape, and may be bent from the first sub-sensing line SNL-1 to extend in the first direction DR1. The dummy electrode DME may be located between the first sub-sensing line SNL-1 and the sensing electrode SE.

The second sub-sensing line SNL-2 may extend to pass through the dummy electrode DME to be connected to the sensing electrode SE. For example, an opening OP may be defined in the dummy electrode DME, and the second sub-sensing line SNL-2 may extend to the sensing electrode SE through the opening OP.

The opening OP may separate the dummy electrode DME in the second direction DR2. For example, the dummy electrode DME may include the first sub-dummy electrode DME-1, and a second sub-dummy electrode DME-2 that is located in the second direction DR2 with respect to the first sub-dummy electrode DME-1. An opening OP may be defined between the first sub-dummy electrode DME-1 and the second sub-dummy electrode DME-2. The second sub-sensing line SNL-2 may be located between the first sub-dummy electrode DME-1 and the second sub-dummy electrode DME-2 to extend to the sensing electrode SE.

The ground line GNL may have a zigzag shape and may extend in the second direction DR2. The ground line GNL may be repeatedly bent in the first diagonal direction DDR1 and the second diagonal direction DDR2 to extend in the second direction DR2. The ground line GNL may extend to overlap the first and second branch parts BP1 and BP2 portions of the dummy electrode DME when viewed on a plane (or in a plan view).

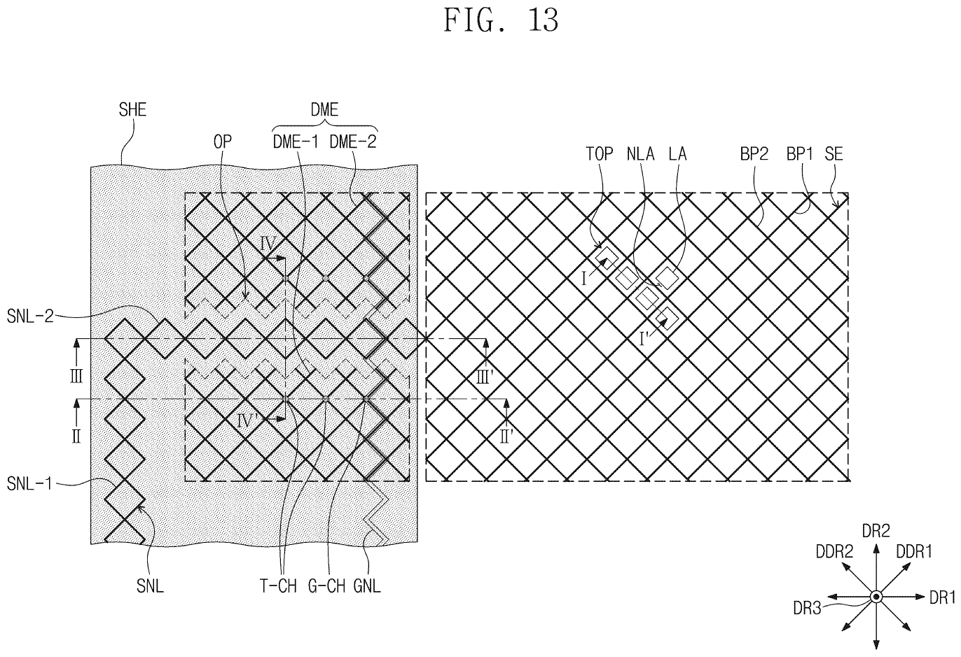

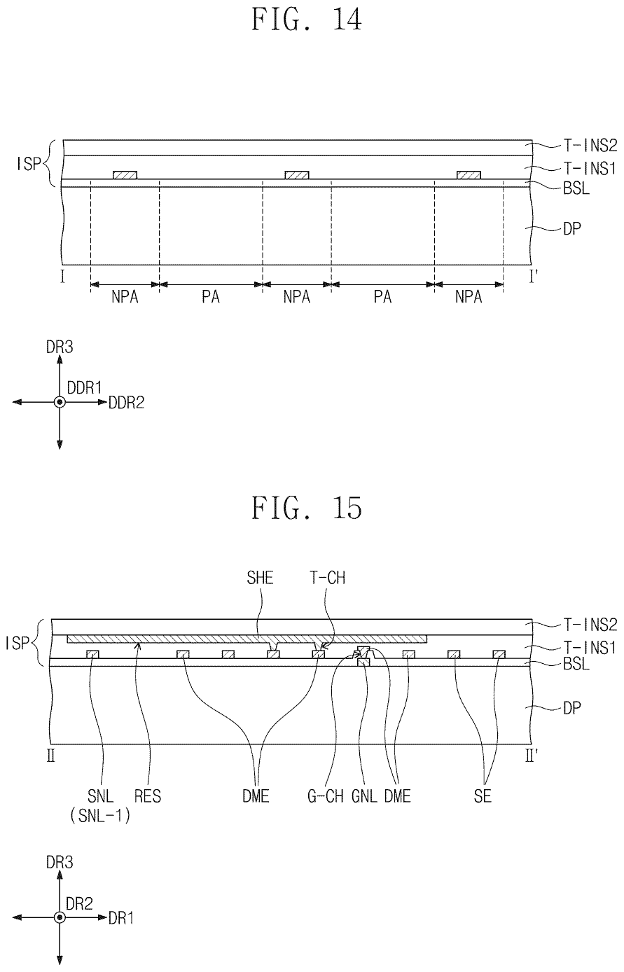

FIG. 14 is a cross-sectional view taken along the line I-I′ illustrated in FIG. 13.

By way of example, in FIG. 14, the emission areas LA and the non-emission areas NLA are illustrated along with the input sensing part ISP.

Referring to FIG. 14, a base layer BSL may be located on the display panel DP. For example, the base layer BSL may be located on the thin film encapsulation layer TFE of the above-described display panel DP. The base layer BSL may include an inorganic insulating layer.

A sensing electrode SE may be located on the base layer BSL. The sensing electrode SE may be arranged to overlap the non-emission area NLA. A first insulating layer T-INS1 may be located on the base layer BSL to cover the sensing electrode SE. The first insulating layer T-INS1 may include an organic insulating layer.

The second insulating layer T-INS2 may be located on the first insulating layer T-INS1. The second insulating layer T-INS2 may include an organic insulating layer or an inorganic insulating layer.

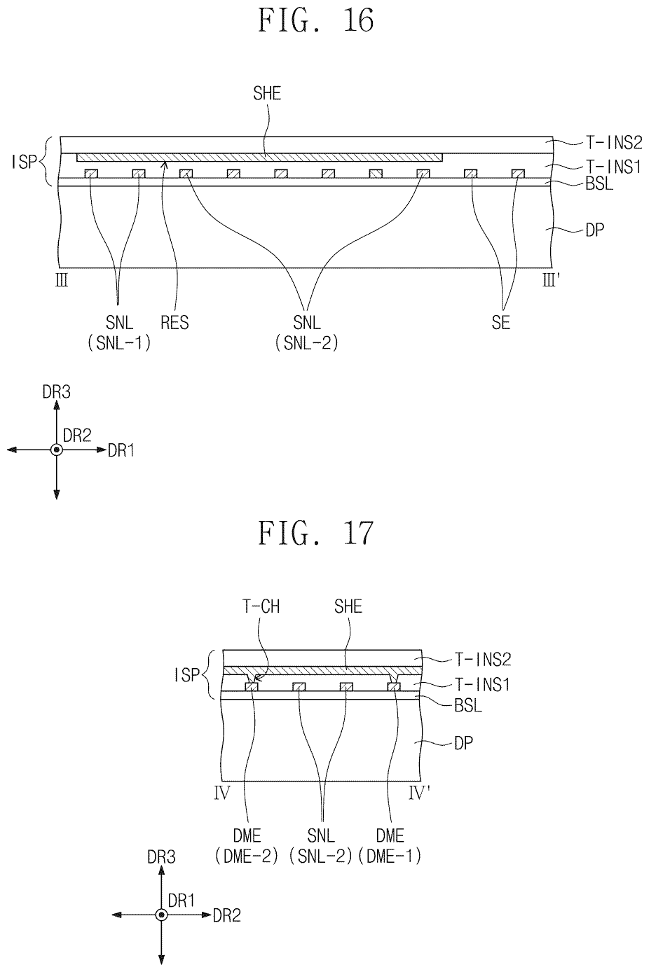

FIG. 15 is a cross-sectional view taken along the line II-II′ illustrated in FIG. 13. FIG. 16 is a cross-sectional view taken along the line III-III′ illustrated in FIG. 13. FIG. 17 is a cross-sectional view taken along the line IV-IV′ illustrated in FIG. 13.

In FIGS. 15, 16, and 17, the emission areas LA and the non-emission areas NLA are omitted, and by way of example, the width of the electrodes and the distance between the electrodes are illustrated to be narrower than those of FIG. 14.

Referring to FIGS. 15, 16, and 17, the ground line GNL may be located on an upper surface of the display panel DP. The upper surface of the display panel DP may be defined as an upper surface of the thin film encapsulation layer TFE described above. The base layer BSL may be located on the ground line GNL. The base layer BSL may be located on the display panel DP to cover the ground line GNL.

The sensing line SNL, the dummy electrode DME, and the sensing electrode SE may be located on the base layer BSL. The sensing line SNL, the dummy electrode DME, and the sensing electrode SE may be located on the same layer. The sensing line SNL, the dummy electrode DME, and the sensing electrode SE may be formed by simultaneously patterning the same material.

The ground line GNL may be located under the dummy electrode DME. The dummy electrode DME may be electrically connected to the ground line GNL through a contact hole G-CH defined in the base layer BSL. The ground line GNL may receive a ground voltage. Accordingly, the ground voltage may be applied to the dummy electrode DME through the ground line GNL.

Referring to FIGS. 13 and 16, the first sub-sensing line SNL-1, the second sub-sensing line SNL-2, and the sensing electrode SE may be located on the same layer to be integrally formed.

Referring to FIG. 15, the dummy electrode DME may be located between the first sub-sensing line SNL-1 and the sensing electrode SE.

Referring to FIG. 17, the second sub-sensing line SNL-2 may be located between the first sub-dummy electrode DME-1 and the second sub-dummy electrode DME-2.

Referring to FIGS. 15, 16, and 17, a first insulating layer T-INS1 may be located on the sensing line SNL, the dummy electrode DME, and the sensing electrode SE. The first insulating layer T-INS1 may be located on the base layer BSL to cover the sensing line SNL, the dummy electrode DME, and the sensing electrode SE.

A shield electrode SHE may be located on the first insulating layer T-INS1. A recessed part RES may be defined on an upper surface of the first insulating layer T-INS1, and the shield electrode SHE may be located on the recessed part RES.

The shield electrode SHE may be located on the sensing line SNL and the dummy electrode DME. When viewed on a plane (or in a plan view), the shield electrode SHE may overlap the sensing line SNL and the dummy electrode DME to cover the sensing line SNL and the dummy electrode DME.

The shield electrode SHE may be electrically connected to the dummy electrode DME through contact holes T-CH defined in the first insulating layer T-INS1. As described above, the ground voltage may be applied to the dummy electrode DME through the ground line GNL. Accordingly, the shield electrode SHE may be electrically connected to the dummy electrode DME to receive a ground voltage through the dummy electrode DME.

The shield electrode SHE may include a conductive material. The touch openings TOP described above may not be defined in the shield electrode SHE. Accordingly, to transmit the light generated in the emission areas LA, the shield electrode SHE may include a transparent electrode that transmits the light.

A second insulating layer T-INS2 may be located on the shield electrode SHE. The second insulating layer T-INS2 may be located on the first insulating layer T-INS1 to cover the shield electrode SHE.

The electromagnetic signal EMS generated by the driving signal TS applied to the sensing line SNL may be shielded not to be radiated to the outside due to the shield electrode SHE located on the sensing line SNL. Furthermore, when the ground voltage is applied to the shield electrode SHE through the ground line GNL and the dummy electrode DME, the shield electrode SHE may more effectively shield the electromagnetic signal EMS.

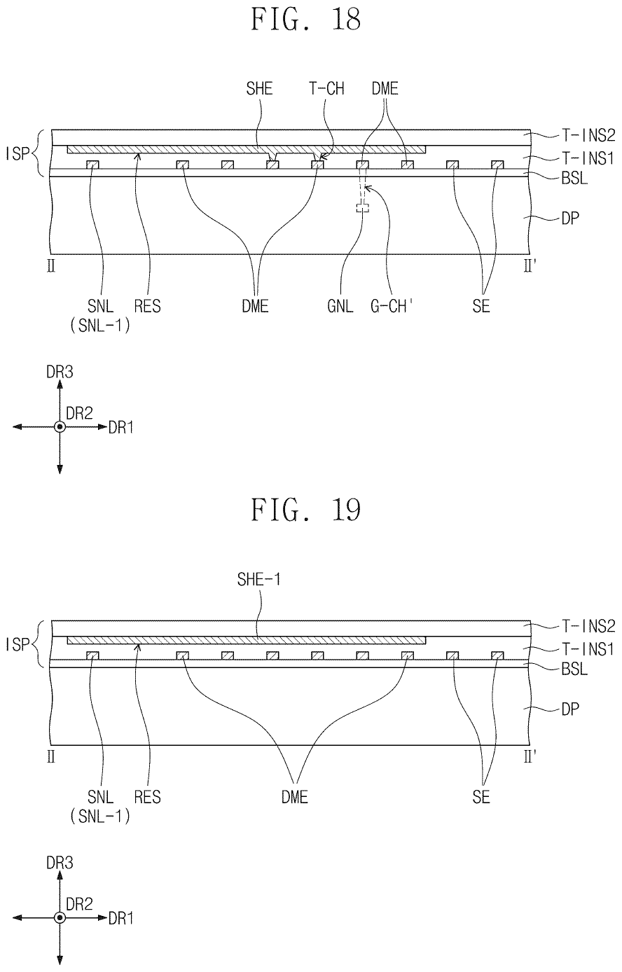

FIG. 18 is a view illustrating a disposition position of a ground line according to some embodiments of the present disclosure.

By way of example, FIG. 18 is illustrated as a cross-section corresponding to FIG. 15, and in FIG. 18, the ground line GNL and the contact hole G-CH′ are illustrated by dotted lines. Hereinafter, a configuration illustrated in FIG. 18 will be described, focusing on a configuration that is different from the configuration illustrated in FIG. 15.

Referring to FIGS. 15 and 18, the ground line GNL may be located at various positions. In FIG. 15, the ground line GNL is located on the upper surface of the display panel DP, but the present disclosure is not limited thereto, and the ground line GNL may be located in the display panel DP. For example, the ground line GNL may be located on the same layer as the second connection electrode CNE2 or the first connection electrode CNE1 illustrated in FIG. 8. In this case, the dummy electrode DME may be connected to the ground line GNL through a contact hole G-CH′ defined in layers located on the second connection electrode CNE2 or the first connection electrode CNE1.

FIGS. 19 to 23 are diagrams illustrating a configuration of shield electrodes according to some embodiments of the present disclosure.

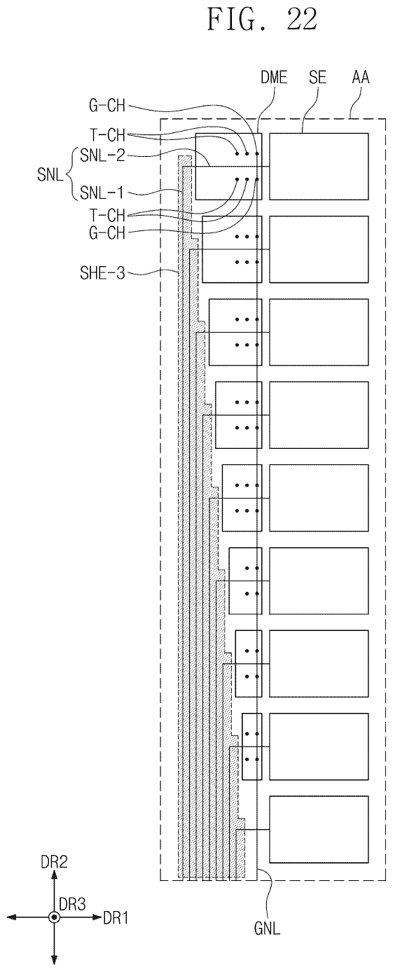

By way of example, FIGS. 19, 20, 21, and 23 are illustrated in a cross section corresponding to FIG. 15, and FIG. 22 is illustrated in a plan view corresponding to FIG. 12. Hereinafter, configurations illustrated in FIGS. 19 to 23 will be described, focusing on configurations that are different from those illustrated in FIGS. 15 and 12.

Referring to FIG. 19, a shield electrode SHE-1 may be located on the sensing line SNL and the dummy electrode DME, and may not be connected to the dummy electrode DME. The ground line GNL may not be located under the dummy electrode DME. Accordingly, a ground voltage may not be applied to the dummy electrode DME and the shield electrode SHE-1. The shield electrode SHE-1 may be in a floating state.

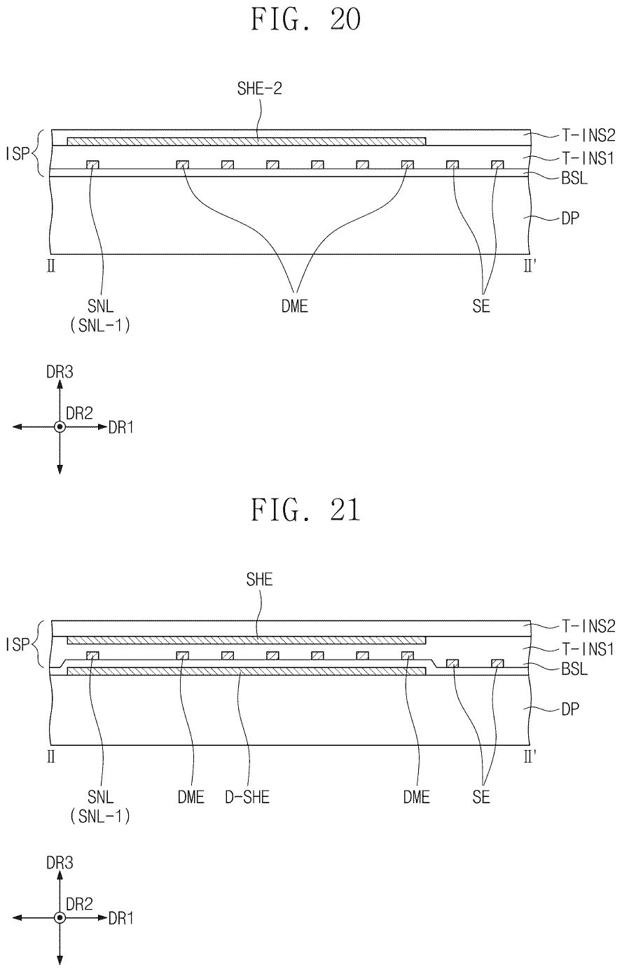

Referring to FIG. 20, a recessed part RES may not be defined on an upper surface of the first insulating layer T-INS1. Accordingly, the first insulating layer T-INS1 may have a flat upper surface. The shield electrode SHE-2 and the first insulating layer T-INS1 may be located on a flat upper surface.

Referring to FIG. 21, the shield electrode SHE may be located on the sensing line SNL and the dummy electrode DME, and a dummy shield electrode D-SHE may be located under the sensing line SNL and the dummy electrode DME. The shield electrode SHE and the dummy shield electrode D-SHE may be in a floating state without being connected to the dummy electrode DME.

The dummy shield electrode D-SHE may be located on the display panel DP, and the base layer BSL may be located on the dummy shield electrode D-SHE.

The dummy shield electrode D-SHE may overlap the shield electrode SHE when viewed on a plane (or in a plan view).

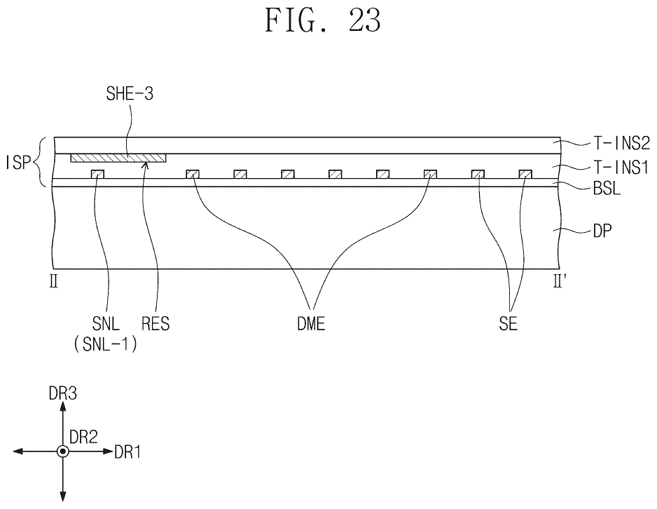

Referring to FIGS. 22 and 23, the shield electrode SHE-3 may be located only on the sensing line SNL (specifically, on the first sub-sensing line SNL-1), and may not be located on the dummy electrode DME. Accordingly, the shield electrode SHE-3 may not be located on the dummy electrode DME not to overlap the dummy electrode DME when viewed on a plane (or in a plan view).

According to some embodiments of the present disclosure, the shield electrode is located on the sensing lines, to which the driving signal is applied, and an electromagnetic signal that may be generated according to the driving signal and may be radiated to the outside may be shield by the shield electrode. Accordingly, electromagnetic interferences with the external devices may be prevented or reduced.

Although aspects of some embodiments of the present disclosure have been described for illustrative purposes, those skilled in the art will appreciate that various modifications, and substitutions are possible, without departing from the scope and spirit of embodiments according to the present disclosure as disclosed in the accompanying claims, and their equivalents.

Accordingly, the technical scope of the present disclosure should not be limited to the contents described in the detailed description of the specification but should be defined by the appended claims, and their equivalents.

What is claimed is:

1. An input sensing part comprising:
a sensing electrode;
a dummy electrode adjacent to the sensing electrode;
a sensing line adjacent to the dummy electrode, and extending to pass through the dummy electrode to be connected to the sensing electrode; and
a shield electrode on the sensing line, and overlapping the sensing line in a plan view.

2. The input sensing part of claim 1, wherein the shield electrode is on the dummy electrode, and overlaps the dummy electrode in the plan view.

3. The input sensing part of claim 2, wherein the shield electrode is electrically connected to the dummy electrode, and a ground voltage is applied to the shield electrode through the dummy electrode.

4. The input sensing part of claim 2, further comprising:
an insulating layer on the sensing line and the dummy electrode,
wherein the shield electrode is on the insulating layer.

5. The input sensing part of claim 4, wherein the shield electrode is electrically connected to the dummy electrode through a contact hole defined in the insulating layer.

6. The input sensing part of claim 5, further comprising:
a ground line under the dummy electrode, and electrically connected to the dummy electrode.

7. The input sensing part of claim 4, wherein the shield electrode is in a recessed part defined in an upper surface of the insulating layer.

8. The input sensing part of claim 4, wherein the shield electrode is on a flat upper surface of the insulating layer.

9. The input sensing part of claim 2, wherein the shield electrode is in a floating state.

10. The input sensing part of claim 2, further comprising:
a dummy shield electrode under the sensing electrode and the dummy electrode, and overlapping the shield electrode in the plan view.

11. The input sensing part of claim 2, wherein the shield electrode is not on the dummy electrode such that it does not overlap the dummy electrode in the plan view.

12. The input sensing part of claim 1, wherein the sensing electrode, the dummy electrode, and the sensing line have a mesh shape, and
wherein the shield electrode is provided in a form of a whole electrode and covers the sensing line and the dummy electrode.

13. The input sensing part of claim 12, wherein the shield electrode includes a transparent electrode.

14. The input sensing part of claim 1, wherein the sensing electrode and the dummy electrode are adjacent to each other in a first direction,
wherein the sensing line includes:
a first sub sensing line extending in a second direction crossing the first direction; and
a second sub sensing line bent from the first sub sensing line to extend in the first direction, and extending to pass through the dummy electrode to be connected to the sensing electrode, and
wherein the dummy electrode is between the first sub sensing line and the sensing electrode.

15. The input sensing part of claim 14, wherein the dummy electrode includes:
a first sub dummy electrode; and
a second dummy electrode arranged in the second direction with respect to the first sub dummy electrode, and
wherein the second sub sensing line is between the first sub dummy electrode and the second sub dummy electrode to extend to the sensing electrode.

16. The input sensing part of claim 14, wherein the first and second sub sensing lines and the sensing electrode are integrally formed.

17. A display device comprising:
a display panel; and
an input sensing part on the display panel,
wherein the input sensing part includes:
a sensing electrode;
a dummy electrode adjacent to the sensing electrode;
a sensing line adjacent to the dummy electrode, and extending to pass through the dummy electrode to be connected to the sensing electrode;
a shield electrode on the sensing line and the dummy electrode, and overlapping the sensing line and the dummy electrode in a plan view; and
a ground line under the dummy electrode, and electrically connected to the dummy electrode.

18. The display device of claim 17, wherein the ground line is on an upper surface of the display panel.

19. The display device of claim 17, wherein the ground line is in the display panel.

20. An electronic device comprising:
a processor; and
a display device configured to receive an image signal from the processor, and configured to provide a user with an image corresponding to the image signal,
wherein the display device includes:
a display panel; and
an input sensing part on the display panel, and
wherein the input sensing part includes:
a sensing electrode;
a dummy electrode adjacent to the sensing electrode;
a sensing line adjacent to the dummy electrode, and extending to pass through the dummy electrode to be connected to the sensing electrode; and
a shield electrode on the sensing line and the dummy electrode, and overlapping the sensing line and the dummy electrode in a plan view.
